(19) United States
(12) Patent Application Publication
(10) Pub. No.: US 2014/0023178 A1
(43) Pub. Date: Jan. 23, 2014

(54) X-RAY PHOTOGRAPHING APPARATUS AND METHOD

(71) Applicant: Samsung Electronics Co., Ltd., Suwon-si (KR)

(72) Inventors: Il-hwan KIM, Seoul (KR); Do-yoon KIM, Hwaseong-si (KR); Yong-chul KIM, Seoul (KR); Shang-hyeun PARK, Yongin-si (KR); Tae-won JEONG, Yongin-si (KR)

(73) Assignee: Samsung Electronics Co., Ltd., Suwon-si (KR)

(21) Appl. No.: 13/947,237

(22) Filed: Jul. 22, 2013

(30) Foreign Application Priority Data
Jul. 23, 2012 (KR) 10-2012-0080248

(51) Int. Cl. G01N 23/04

(52) U.S. Cl. CPC G01N 23/04
USPC 378/62

(57) ABSTRACT

An X-ray photographing apparatus includes: a plurality of X-ray generators which is two-dimensionally arranged and independently generates X-rays; and a plurality of X-ray detectors which is arranged in a one-to-one correspondence with the plurality of X-ray generators and independently detects the X-rays generated by the plurality of X-ray generators.

### CROSS-REFERENCE TO RELATED APPLICATIONS

This application claims priority to Korean Patent Application No. 10-2012-0080248, filed on Jul. 23, 2012, and all the benefits accruing therefrom under 35 U.S.C. §119, the disclosure of which is incorporated herein in its entireties by reference.

### BACKGROUND

1. Field

Provided is an X-ray photographing apparatus and a method thereof.

2. Description of the Related Art

X-rays are used in industrial, scientific and medical areas for nondestructive testing, inspections of structures and properties of materials, image diagnosis, security searches and so forth. In general, an X-ray photographing apparatus consists of an X-ray generator for emitting X-rays and an X-ray detector for detecting the emitted X-rays which have passed through an object.

X-ray detectors have been modified to use digital methods instead of film methods. However, an electron generation device using a cathode of a tungsten filament scheme has been developed and used in many X-ray generators. Accordingly, one X-ray photographing apparatus is equipped with one electron generation device.

### SUMMARY

Provided is a flat-type X-ray source including a plurality of X-ray generators using a cold-field-emission electron source.

Provided is X-ray photographing apparatuses for independently driving a plurality of X-ray generators and detecting X-rays in correspondence with the plurality of X-ray generators.

Additional aspects will be set forth in part in the description which follows and, in part, will be apparent from the description, or may be learned by practice of the presented embodiments.

According to the present invention, an X-ray photographing apparatus includes: a plurality of X-ray generators which is two-dimensionally arranged and independently generates X-rays; and a plurality of X-ray detectors in a one-to-one correspondence with the plurality of X-ray generators and independently detects the X-rays generated by the plurality of correspond X-ray generators.

Each of the plurality of X-ray detectors may detect X-rays in synchronization with a corresponding X-ray generator.

Adjacent X-ray generators from among the plurality of X-ray generators may alternately generate X-rays.

The plurality of X-ray generators may be arranged in a matrix form, and at least two X-ray generators in different columns and rows may simultaneously generate X-rays.

X-rays generated by each of the plurality of X-ray generators may be irradiated on a region including a corresponding X-ray detector.

Each of the plurality of X-ray detectors may detect only X-rays generated by a corresponding X-ray generator.

Each of the plurality of X-ray generators may include: an electron emission device which emits electrons; an anode which generates X-rays by collision with the electrons emitted by the electron emission device; and a shielding window which shields some of the X-rays so that the X-rays travel towards a corresponding X-ray detector.

An opening may be defined in the shielding window and guide the X-rays from the anode to the corresponding X-ray detector.

The opening may have a tapered cross-sectional shape.

A length of the opening may increase in a direction from the anode towards the corresponding X-ray detector.

A maximum length the opening in a first direction may be less than a length of the corresponding X-ray detector in the first direction.

An inclined angle α of the opening may satisfy the inequality tan⁻¹[d/((l−w)/2+l)]≦α≦tan⁻¹[d/(\sqrt{2 l}−w)/2], where ‘d’ denotes a cross-sectional distance from the anode to the corresponding X-ray detector, ‘l’ denotes a length of the corresponding X-ray detector in a first direction, and ‘w’ denotes a minimum length of the opening defined in the shielding window in the first direction.

All of the X-ray detectors may detect X-rays four single detections or less.

According to the present invention, an X-ray photographing method of an X-ray photographing apparatus includes a first X-ray generation operation including X-ray generators arranged in odd rows of odd columns among a plurality of X-ray generators arranged in a matrix form, generating first X-rays; a first X-ray detection operation including X-ray detectors arranged in odd rows of odd columns among a plurality of X-ray detectors arranged in a matrix form corresponding to the plurality of X-ray generators, detecting the generated first X-rays; a second X-ray generation operation including X-ray generators arranged in even rows of odd columns among the plurality of X-ray generators arranged in the matrix form, generating second X-rays; and a second X-ray detection operation including X-ray detectors arranged in even rows of odd columns among the plurality of X-ray detectors arranged in the matrix form corresponding to the plurality of X-ray generators, detecting the generated second X-rays. The X-ray photographing apparatus includes the plurality of X-ray generators arranged in the matrix form, and the plurality of X-ray detectors arranged in the matrix form corresponding to the plurality of X-ray generators.

The method may further include: third X-ray generation operation including X-ray generators arranged in odd rows of even columns among the plurality of X-ray generators arranged in the matrix form, generating third X-rays; and a third X-ray detection operation including X-ray detectors arranged in odd rows of even columns among the plurality of X-ray detectors arranged in the matrix form corresponding to the plurality of X-ray generators, detecting the generated third X-rays.

The method may further include: a fourth X-ray generation operation including X-ray generators arranged in even rows of even columns among the plurality of X-ray generators arranged in the matrix form, generating fourth X-rays; and a fourth X-ray detection operation including X-ray detectors arranged in even rows of even columns among the plurality of X-ray detectors arranged in the matrix form corresponding to the plurality of X-ray generators, detecting the generated fourth X-rays.

The first X-ray generation operation may further include X-ray generators arranged in even rows of even columns among the plurality of X-ray generators arranged in the matrix form, generating the first X-rays, and the first X-ray detection operation may further include X-ray detectors arranged in even rows of even columns among the plurality of X-ray detectors arranged in the matrix form corresponding to the plurality of X-ray generators, detecting the generated first X-rays.

The second X-ray generation operation may further include X-ray generators arranged in odd rows of even columns among the plurality of X-ray generators arranged in the matrix form, generating the second X-rays, and the second X-ray detection operation may further include X-ray detectors arranged in odd rows of even columns among the plurality of X-ray detectors arranged in the matrix form corresponding to the plurality of X-ray generators, detecting the generated second X-rays.

X-rays generated by each of the plurality of X-ray generators may be irradiated on a region in a corresponding X-ray detector.

Each of the plurality of X-ray detectors may detect only X-rays generated by a corresponding X-ray generator.

### BRIEF DESCRIPTION OF THE DRAWINGS

These and/or other features of the invention will become apparent and more readily appreciated from the following description of the embodiments, taken in conjunction with the accompanying drawings of which:

FIG. 1 is a schematic cross-sectional view of an X-ray photographing apparatus according to an embodiment of the present invention;

FIG. 2 is a top plan view of an electron emission device array in the X-ray photographing apparatus of FIG. 1, according to an embodiment of the present invention;

FIG. 3 is a top plan view of a structure in which anodes and shielding windows are combined in the X-ray photographing apparatus of FIG. 1, according to an embodiment of the present invention;

FIG. 4 is a top plan view of an X-ray detector array in the X-ray photographing apparatus of FIG. 1, according to an embodiment of the present invention;

FIGS. 5A to 5D are diagrams for describing a method for photographing X-rays according to an embodiment of the present invention;

FIGS. 6A and 6B are diagrams for describing a method for photographing X-rays according to another embodiment of the present invention; and

FIG. 7 is a schematic cross-sectional view of an X-ray photographing apparatus according to another embodiment of the present invention.

### DETAILED DESCRIPTION

Reference will now be made in detail to embodiments of an X-ray photographing apparatus, examples of which are illustrated in the accompanying drawings, where like reference numerals refer to the like elements throughout, and thus their repetitive description will be omitted. In this regard, the illustrated embodiments may have different forms and should not be construed as being limited to the descriptions set forth herein. Accordingly, the embodiments are merely described below, by referring to the figures, to explain aspects of the present invention.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, connected may refer to elements being physically and/or electrically connected to each other. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

An electron generation device using a cathode of a tungsten filament scheme has been developed and used in many X-ray generators. Accordingly, one X-ray photographing apparatus is equipped with one electron generation device.

Since X-ray detectors are generally of a flat type, a certain distance is needed between an X-ray generator and an object to acquire an image from a single electron generation device, which undesirably limits a structure and application of an X-ray photographing apparatus. In addition, since a predefined area of each object is captured by a single X-ray generator, selecting and capturing only a predetermined part of the object may be difficult. Therefore, there remains a need for an improved X-ray photographing apparatus having a flexible structure and application thereof, and which provides selection and a predetermined part of an object.

Hereinafter, the invention will be described in detail with reference to the accompanying drawings.

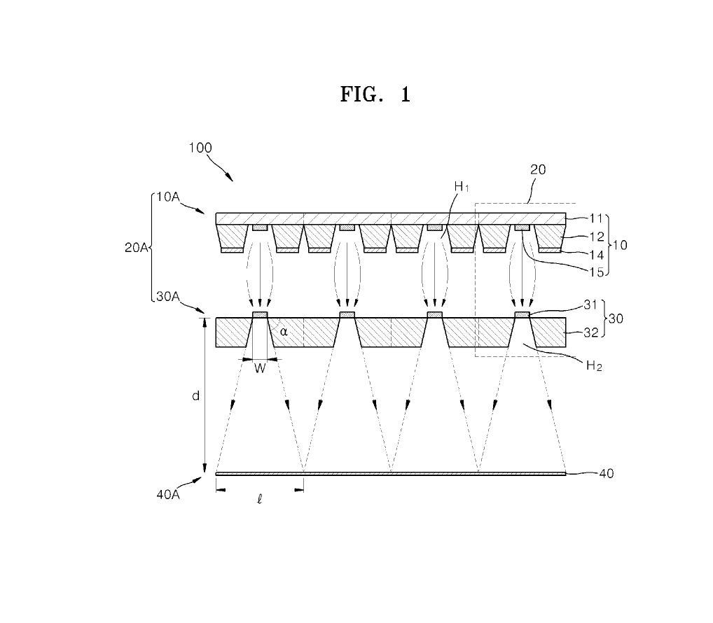

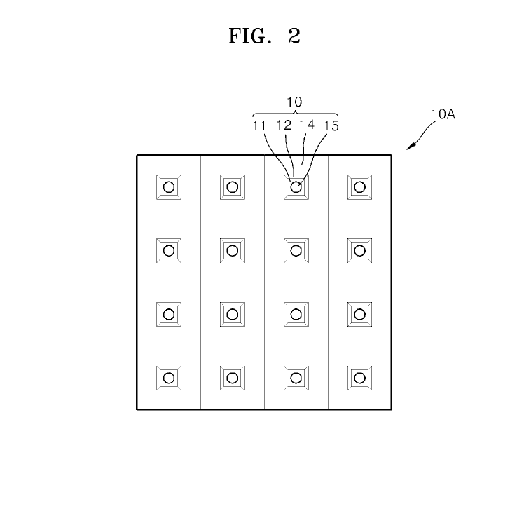

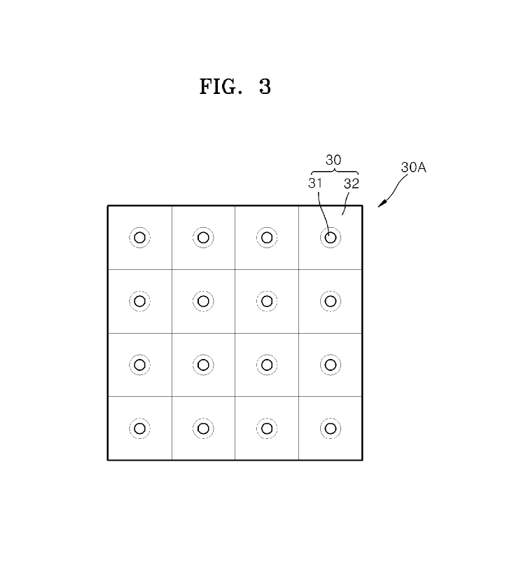

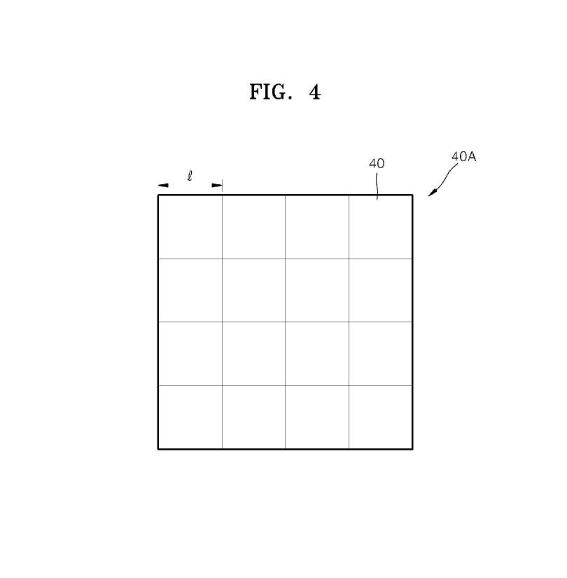

FIG. 1 is a schematic cross-sectional view of an X-ray photographing apparatus 100 according to an embodiment of the present invention, FIG. 2 is a top plan view of an electron emission device array 10A in the X-ray photographing apparatus 100 of FIG. 1, according to an embodiment of the present invention, FIG. 3 is a top plan view of an X-ray emission device array 30A in which anodes 31 and shielding windows 32 are combined in the X-ray photographing apparatus 100 of FIG. 1, according to an embodiment of the present invention, and FIG. 4 is a top plan view of an X-ray detector array 40A in the X-ray photographing apparatus 100 of FIG. 1, according to an embodiment of the present invention.

Referring to FIGS. 1, 2, 3 and 4, the X-ray photographing apparatus 100 may include a plurality of X-ray generators 20 capable of independently generating X-rays, and a plurality of X-ray detectors 40 disposed in a one-to-one correspondence with the plurality of X-ray generators 20 and independently detecting the X-rays generated by the plurality of X-ray generators 20. An X-ray generation device array 20A may include the plurality of X-ray generators 20 in a matrix form, but not being limited thereto.

Each of the plurality of X-ray generators 20 includes an electron emission device 10 for emitting electrons, and an X-ray emission device 30 for emitting X-rays by collision with the electrons emitted by the electron emission device 10. Referring to FIGS. 1 and 2, the electron emission device 10 includes a cathode electrode 11, a gate electrode 14 arranged apart from the cathode electrode 11, an insulation layer 12 arranged between the cathode electrode 11 and the gate electrode 14, and an electron emission source 15.

The cathode electrode 11 and the gate electrode 14 may include a conductive material, such as a metal or a conductive metal oxide. In one embodiment, for example, the cathode electrode 11 and the gate electrode 14 may include a metal, such as titanium (Ti), platinum (Pt), ruthenium (Ru), gold (Au), silver (Ag), molybdenum (Mo), Aluminum (Al), tungsten (W), or Copper (Cu), or a conductive metal oxide, such as Indium Tin Oxide (“ITO”), Aluminum Zinc Oxide (“AZO”), Indium Zinc Oxide (“IZO”), tin oxide (SnO₂), or indium oxide (InO₂).

The cathode electrode 11 applies a voltage to the electron emission source 15 and may have a substantially flat or plate shape. The gate electrode 14 receives a voltage of a different magnitude from that applied to the cathode electrode 11 and induces the electron emission source 15 to emit electrons. The gate electrode 14 may have a ring shape in the plan view. An opening H1 is defined in the gate electrode 14.

The insulation layer 12 is arranged between the cathode electrode 11 and the gate electrode 14 to reduce or effectively prevent electrical conduction therebetween. Within each X-ray generator 20, the insulation layer 12 may be a single, unitary, indivisible member, but not being limited thereto. In addition, since the insulation layer 12 supports the gate electrode 14, the insulation layer 12 may have substantially the same planar shape as the gate electrode 14 or may have any of a number of structures to support the gate electrode 14, so long as the insulation layer 12 does not obstruct an electron traveling path. An opening aligned with the opening H1 in the gate electrode 14, may be defined in the insulation layer 12. The aligned openings may expose the electron emission source 15 and/or a portion of the cathode 11, but the present invention is not limited thereto or thereby.

The electron emission source 15 emits electrons in response to voltages applied to the cathode electrode 11 and the gate electrode 14. The electron emission source 15 may include a material capable of emitting electrons. In one embodiment, for example, the electron emission source 15 may include a metal, a silicon, an oxide, a diamond, a diamond-like-carbon (“DLC”), a carbide compound, a nitrogen compound, a carbon nanotube or a carbon nanofiber, but not being limited thereto.

The electrons emitted by the electron emission source 15 are generally emitted through the opening H1 defined in the gate electrode 14, as illustrated by the groups of downward arrows in FIG. 1. However, some of the electrons emitted by the electron emission source 15 may be incident onto the insulation layer 12. To minimize collision between the electrons emitted by the electron emission source 15 and the insulation layer 12, the insulation layer 12 may be arranged to be inclined against the electron emission source 15. As illustrated in FIG. 1, a length of the opening defined in the insulation layer 12 increases in a direction away from the electron emission source 15 and toward the gate electrode 14. Inner sidewalls of the insulation layer 12 are inclined from the cathode 11 in a direction away from the electron emission source 15 disposed in the opening defined in the insulation layer 12.

The plurality of electron emission devices 10 may be individually manufactured and assembled, but not being limited thereto. The individually provided plurality of electron emission devices 10 may be two-dimensionally arranged, such as in the configuration shown in FIG. 2. The plurality of electron emission devices 10 may be arranged in an m×n matrix form (where ‘m’ and ‘n’ are natural numbers equal to or greater than 2), and may independently emit electrons.

The X-ray emission device 30 may include an anode 31 for generating X-rays by collision with the electrons emitted by the electron emission device 10, and a shielding window 32 for shielding the generated X-rays from traveling towards X-ray detectors 40 other than a corresponding X-ray detector 40. Within each X-ray generator 20, the shielding window 32 may be a single, unitary, indivisible member, but not being limited thereto.

The anode 31 may be arranged on a path along which the electrons emitted by the electron emission device 10 travel. The anode 31 generates X-rays by the electrons emitted by the electron emission device 10 colliding therewith. The anode 31 includes a target (not shown) including a metal, such as Mo, Ag, W, chromium (Cr), iron (Fe), cobalt (Co), or Cu or a metal alloy, but not being limited thereto.

The X-rays generated by the anode 31 are emitted in an isotropic direction. Since X-rays irradiated on only a corresponding X-ray detector 40 are desired and meaningful, the shielding window 32 may include an opening H2 defined therein for forcing the X-rays to travel between the anode 31 and the corresponding X-ray detector 40. The opening H2 may have a tapered shape. In one embodiment, for example, the opening H2 may have a shape of which a planar area or planar length increases in a direction from the anode 31 towards the corresponding X-ray detector 40. Inner sidewalls of the shielding window 32 are inclined from a lower plane of the anode 31 (or an upper plane of the shielding windows 32) in a direction away from the anode 31.

When the opening H2 has a tapered shape, an inclined angle α of the opening H2 may satisfy Equation 1.

tan⁻¹[d/((l−w)/2+l)]≦α≦tan⁻¹[d/(\sqrt{2 l}−w)/2] (Equation 1)

where ‘d’ denotes a distance from the anode 31 to the corresponding X-ray detector 40, ‘l’ denotes a length of the corresponding X-ray detector 40 in a first direction, and ‘w’ denotes a minimum length of the opening H2 defined in the shielding window 32 taken in the same first direction. The opening H2 defined in the shielding window 32 may have a minimum planar dimension (e.g., a length or width) in one direction or a minimum planar area, based on a corresponding planar dimension in the same one direction or a corresponding planar area of the overall electron emission source 15 or a portion thereof.

If the inclined angle α of the opening H2 satisfies Equation 1, the X-rays generated by the anode 31 are irradiated on a region of the corresponding X-ray detector 40. Then, the corresponding X-ray detector 40 may detect the X-rays generated by a corresponding X-ray generator 20.

The X-ray emission device 30 and the corresponding X-ray detector 40 may be arranged spaced apart from each other so that an object to be examined with the X-ray photographing apparatus 100 may be interposed therebetween. Accordingly, to reduce or effectively prevent unnecessary X-ray emission, a maximum area or length of the opening H2 may be equal to or less than the area or length of the corresponding X-ray detector 40. In addition, a planar shape of the opening H2 may have substantially the same planar shape as the planar area of the corresponding X-ray detector 40 but is not limited thereto. In one embodiment, for example, even though the corresponding X-ray detector 40 has a rectangular shape in the plan view, the opening H2 may have a circular shape in the plan view.

The shielding window 32 may include a material capable of shielding X-rays, such as a stainless (‘SUS’) or a glass, but not being limited thereto.

The plurality of X-ray emission devices 30 may also be two-dimensionally arranged, such as in the configuration shown in FIG. 3. The plurality of X-ray emission devices 30 may be arranged in an m×n matrix form (where ‘m’ and ‘n’ are natural numbers equal to or greater than 2), and may independently emit X-rays in synchronization with corresponding electron emission devices 10. The plurality of X-ray emission devices 30 may also be individually manufactured and assembled, and then subsequently provided in the desired configuration, but not being limited thereto. In one or more embodiment of the present invention, X-rays generated by the plurality of X-ray generators 20 are respectively irradiated only on corresponding X-ray detectors 40.

Each of the plurality of X-ray detectors 40 detects X-rays emitted by a corresponding X-ray emission device 30. The plurality of X-ray detectors 40 may also be two-dimensionally arranged, such as in the configuration shown in FIG. 4. In one embodiment, for example, the plurality of X-ray detectors 40 may be arranged in an m×n matrix form (where ‘m’ and ‘n’ are natural numbers equal to or greater than 2), and may independently detect X-rays in synchronization with corresponding X-ray generators 20. The plurality of X-ray detectors 40 may be individually manufactured and assembled, but not being limited thereto. Alternatively, the plurality of X-ray detectors 40 may be integral with each other so as to form a single, unitary, indivisible X-ray detector array 40A.

Each of the plurality of X-ray detectors 40 converts the detected X-rays to an electrical signal. A detecting method of the plurality of X-ray detectors 40 is divided into a direct method and an indirect method. In the direct method, X-rays are directly converted into electric charges in a photoconductor (not shown). In the indirect method, X-rays are converted into visible rays in a scintillator (not shown) and then the visible rays are converted into electric charges in a photoelectric conversion device such as a photodiode (not shown). A flat panel detector may be used as the plurality of X-ray detectors 40.

If X-rays generated by the plurality of X-ray generators 20 are respectively irradiated only on corresponding X-ray detectors 40, the plurality of X-ray generators 20 may simultaneously generate X-rays, and the plurality of X-ray detectors 40 may simultaneously detect the X-rays. In one or more embodiment of the present invention, a distance between each of the plurality of X-ray generators 20 and a corresponding X-ray detector 40 may be changed, and only a predetermined region of an object may be desired to be photographed. Accordingly, an amount of radiation of X-rays to photograph an object is minimized, X-rays in the plurality of X-ray generators 20 for correct X-ray detection are independently generated, and the X-rays in corresponding X-ray detectors 40 are independently detected in synchronization with the plurality of X-ray generators 20.

A method for independently photographing X-rays according to the present invention will now be described.

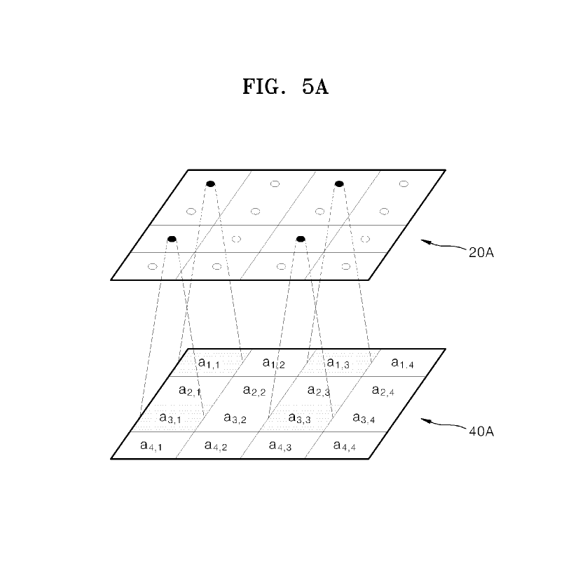

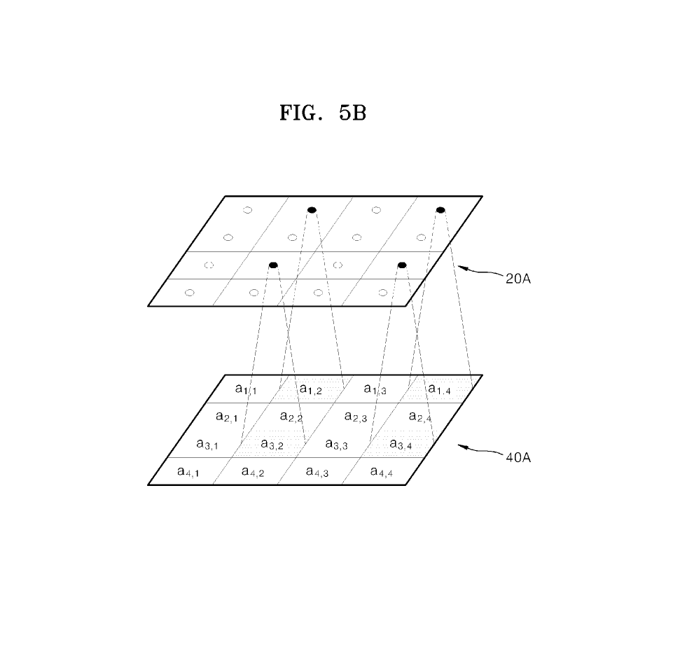

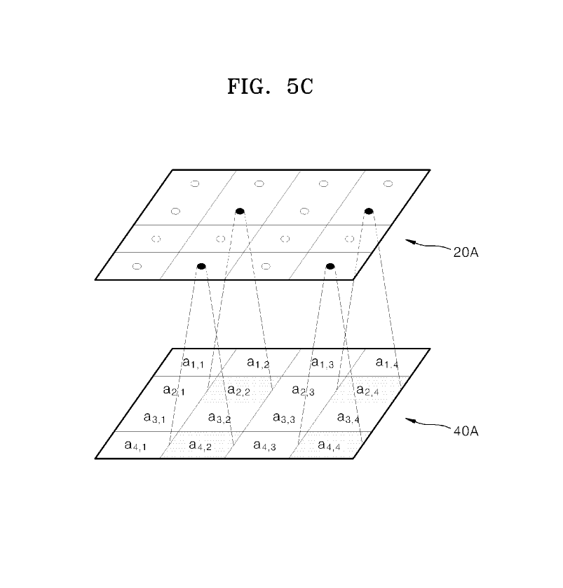

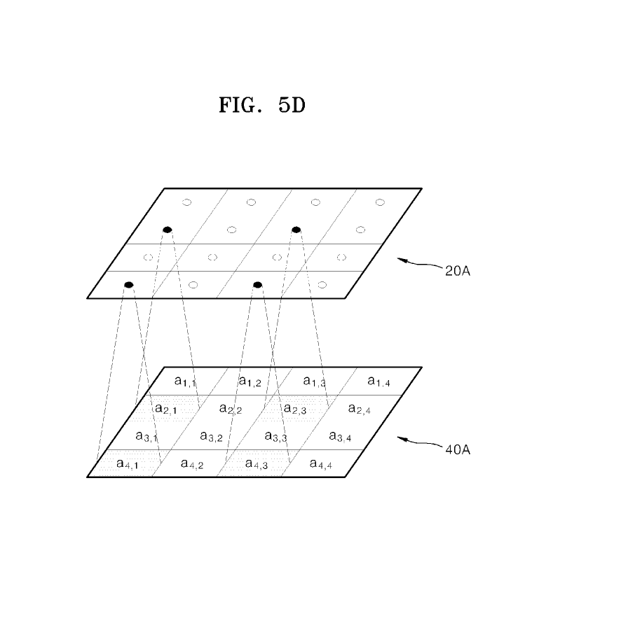

FIGS. 5A to 5D are diagrams for describing an X-ray photographing method according to an embodiment of the present invention. For convenience of description, it is assumed that each opening H2 has a circular planar shape, and each X-ray detector 40 has a rectangular planar shape. However, the present invention is not limited thereto. Both the plurality of X-ray generators 20 and the plurality of X-ray detectors 40 may be arranged in an m×n matrix form (where ‘m’ and ‘n’ are natural numbers equal to or greater than 2). The plurality of X-ray generators 20 and the plurality of X-ray detectors 40 are arranged in a one-to-one correspondence.

In X-ray photographing, neighboring X-ray generators 20 from among the plurality of X-ray generators 20 may alternately generate X-rays instead of generating X-rays at the same time. In one embodiment, for example, after X-ray generators 20 arranged in odd rows of odd columns generate X-rays, X-ray generators 20 arranged in any one of even rows of odd columns, odd rows of even columns, and even rows of even columns, may generate X-rays.

If the X-ray photographing apparatus 100 is used to photograph an object by using all X-rays, when the X-ray generators 20 arranged in odd rows of odd columns generate X-rays, X-ray detectors 40 arranged in odd rows of odd columns detect the X-rays, as shown in FIG. 5A. Thereafter, when the X-ray generators 20 arranged in even rows of odd columns generate X-rays, X-ray detectors 40 arranged in even rows of odd columns detect the X-rays, as shown in FIG. 5B. Thereafter, when the X-ray generators 20 arranged in even rows of even columns generate X-rays, X-ray detectors 40 arranged in even rows of even columns detect the X-rays, as shown in FIG. 5C. Finally, when the X-ray generators 20 arranged in odd rows of even columns generate X-rays, X-ray detectors 40 arranged in odd rows of even columns detect the X-rays, as shown in FIG. 5D. Accordingly, an object may be photographed by detecting the X-rays four times in total.

Although FIGS. 5A to 5D show that X-ray generators 20 arranged in a 2×2 matrix form are grouped and the groups respectively detect X-rays in a single detection so that all of the X-rays are detected in a total four times (e.g., four total single detections) and the X-ray generators 20 generate X-rays clockwise in the plan view of the X-ray generators 20 on a group-by-group basis, the X-ray generation order is not limited thereto. That is, the X-ray generators 20 may alternatively generate X-rays counterclockwise or in an X-letter direction on a group-by-group basis.

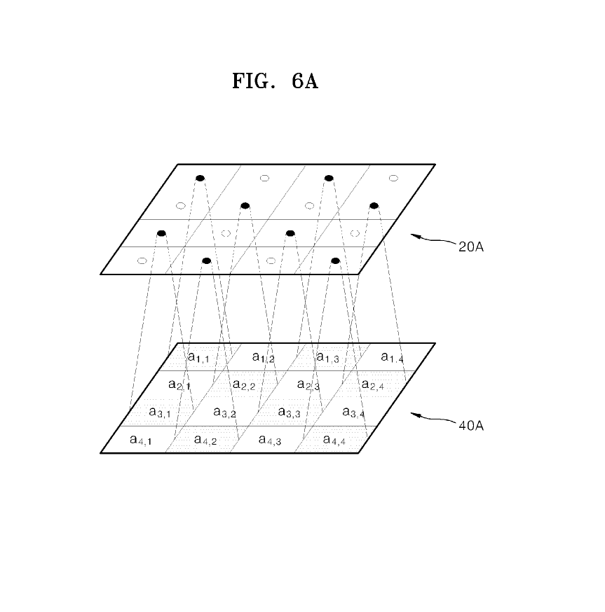

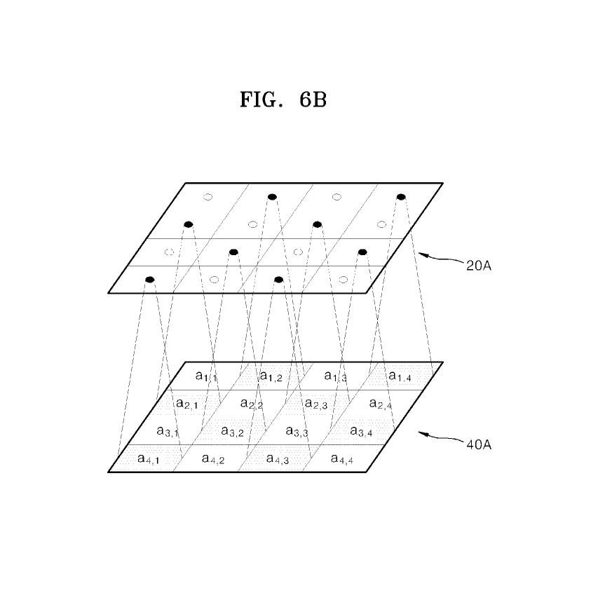

FIGS. 6A and 6B are diagrams for describing an X-ray photographing method according to another embodiment of the present invention. For convenience of description, it is assumed that each opening H2 has a circular planar shape, and each X-ray detector 40 has a rectangular planar shape. However, the present invention is not limited thereto. Both the plurality of X-ray generators 20 and the plurality of X-ray detectors 40 may be arranged in an m×n matrix form (where ‘m’ and ‘n’ are natural numbers equal to or greater than 2). The plurality of X-ray generators 20 and the plurality of X-ray detectors 40 are arranged in a one-to-one correspondence.

In X-ray photographing, neighboring X-ray generators 20 in different columns and rows among the plurality of X-ray generators 20 may simultaneously generate X-rays. In one embodiment, for example, X-ray generators 20 arranged in odd rows of odd columns and X-ray generators 20 arranged in even rows of even columns may simultaneously generate X-rays.

If the X-ray photographing apparatus 100 is used to photograph an object by using all X-rays, when the X-ray generators 20 arranged in odd rows of odd columns and even rows of even columns generate X-rays, X-ray detectors 40 arranged in odd rows of odd columns and even rows of even columns detect the X-rays, as shown in FIG. 6A. Thereafter, when X-ray generators 20 arranged in even rows of odd columns and odd rows of even columns generate X-rays, X-ray detectors 40 arranged in even rows of odd columns and odd rows of even columns detect the X-rays, as shown in FIG. 6B. Accordingly, X-ray generators 20 arranged in a 2×2 matrix form are grouped and the groups respectively detect X-rays in a single detection so that an object may be photographed by detecting the X-rays a total of two times (e.g., two total single detections).

The illustrated embodiment is characterized in that the X-rays are detected a number of times, but where X-rays are detected a number of times, a photographing time may be relatively long. Accordingly, when X-rays are detected N times (where ‘N’ is a natural number equal to or greater than 2), the relatively long photographing time may be reduced by reducing a photographing time to 1/N of a standard photographing time and increasing a tube current applied to the X-ray photographing apparatus 100 by N times a standard current.

In addition, even when a partial region of an object is photographed, the method described above may be applied. That is, only X-ray generators 20 and X-ray detectors 40 corresponding to the partial region of the object may be used to photograph the object in the method described above.

The X-ray photographing apparatus 100 shown in FIG. 1 is a transmission-type X-ray photographing apparatus in which the electron emission device array 10A, the X-ray emission device array 30A, and the X-ray detector array 40A are sequentially arranged in a direction of generated X-ray travel, but not being limited thereto. That is, the transmission-type X-ray photographing apparatus has a simple structure. Alternatively, the X-ray photographing apparatus 100 may be of a reflection type.

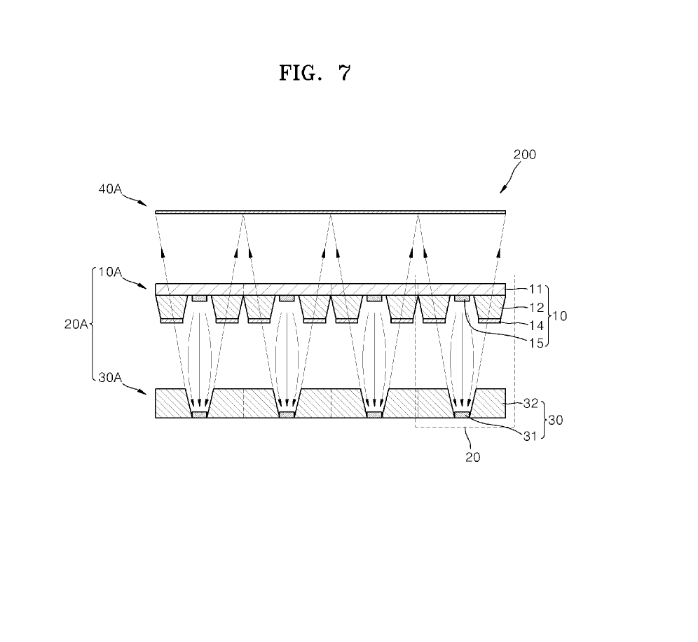

FIG. 7 is a schematic cross-sectional view of an X-ray photographing apparatus 200 according to another embodiment of the present invention. As shown in FIG. 7, the X-ray photographing apparatus 200 may include the X-ray detector array 40A, the electron emission device array 10A, and the X-ray emission device array 30A that are sequentially arranged in a direction opposite to that of generated X-ray travel. As such, to implement the reflection-type X-ray photographing apparatus 200, the electron emission device array 10A may include a material having a high X-ray transmission ratio or may have a cross-sectional thickness configured to transmit X-rays relatively easily. According to the reflection-type X-ray photographing apparatus 200, installation of a cooling device for reducing or effectively preventing heating of anodes 31 may be relatively simple.

As described above, according to one or more embodiment of the present invention, an X-ray source may be realized as a flat type X-ray source by two-dimensionally arranging a plurality of X-ray generators.

In an X-ray photographing apparatus, a plurality of X-ray generators and corresponding X-ray detectors independently operate, and thus, irradiation of X-rays on an unnecessary portion of an object to be examined may be minimized.

X-ray photographing apparatuses of various types and X-ray photographing methods may be implemented by those of ordinary skill in the art based on the scope of the present invention as presented in the above-described embodiments. Therefore, the scope of the present invention is not limited by the above-described embodiments and any of a number of various modifications is intended to be included within the scope of the present invention as disclosed in the appended claims.

What is claimed is:

1. An X-ray photographing apparatus comprising:
a plurality of X-ray generators which is two-dimensionally arranged and independently generates X-rays; and
a plurality of X-ray detectors which is arranged in one-to-one correspondence with the plurality of X-ray generators and independently detects the X-rays generated by the plurality of X-ray generators, respectively.

2. The X-ray photographing apparatus of claim 1, wherein each of the plurality of X-ray detectors detects X-rays in synchronization with a corresponding X-ray generator.

3. The X-ray photographing apparatus of claim 1, wherein adjacent X-ray generators from among the plurality of X-ray generators alternately generate X-rays.

4. The X-ray photographing apparatus of claim 1, wherein, when the plurality of X-ray generators are arranged in a matrix form, at least two X-ray generators in different columns and rows simultaneously generate X-rays.

5. The X-ray photographing apparatus of claim 1, wherein X-rays generated by each of the plurality of X-ray generators are irradiated on a region in a corresponding X-ray detector.

6. The X-ray photographing apparatus of claim 1, wherein each of the plurality of X-ray detectors detects only X-rays generated by a corresponding X-ray generator.

7. The X-ray photographing apparatus of claim 1, wherein each of the plurality of X-ray generators comprises:
an electron emission device which emits electrons;
an anode which generates X-rays by collision with the electrons emitted by the electron emission device; and
a shielding window which shields some of the X-rays so that the generated X-rays travel towards a corresponding X-ray detector.

8. The X-ray photographing apparatus of claim 7, wherein an opening is defined in the shielding window and guides the X-rays from the anode to the corresponding X-ray detector.

9. The X-ray photographing apparatus of claim 8, wherein the opening has a tapered cross-sectional shape.

10. The X-ray photographing apparatus of claim 8, wherein a length of the opening increases in a direction from the anode towards the corresponding X-ray detector.

11. The X-ray photographing apparatus of claim 8, wherein a maximum length of the opening in a first direction is less than a length of the corresponding X-ray detector in the first direction.

12. The X-ray photographing apparatus of claim 8, wherein
an inclined angle α of the opening satisfies the inequality tan⁻¹[d/((l−w)/2+l)]≦α≦tan⁻¹[d/(\sqrt{2 l}−w)/2],
where ‘d’ denotes a cross-sectional distance from the anode to the corresponding X-ray detector, ‘l’ denotes a length of the corresponding X-ray detector in a first direction, and ‘w’ denotes a minimum length of the opening defined in the shielding window in the first direction.

13. The X-ray photographing apparatus of claim 1, wherein each of four or less groups of the X-ray detectors detect X-rays in a single detection such that all of the X-ray detectors detect X-rays in four detections or less.

14. An X-ray photographing method of an X-ray photographing apparatus, the method comprising:
a first X-ray generation operation comprising X-ray generators arranged in odd rows of odd columns among a plurality of X-ray generators arranged in a matrix form, generating first X-rays;
a first X-ray detection operation comprising X-ray detectors arranged in odd rows of odd columns among a plurality of X-ray detectors arranged in a matrix form corresponding to the plurality of X-ray generators, detecting the generated first X-rays;
a second X-ray generation operation comprising X-ray generators arranged in even rows of odd columns among the plurality of X-ray generators arranged in the matrix form, generating second X-rays; and
a second X-ray detection operation comprising X-ray detectors arranged in even rows of odd columns among the plurality of X-ray detectors arranged in the matrix form corresponding to the plurality of X-ray generators, detecting the generated second X-rays,
wherein the X-ray photographing apparatus comprises:
the plurality of X-ray generators arranged in the matrix form, and
the plurality of X-ray detectors arranged in the matrix form corresponding to the plurality of X-ray generators.

15. The method of claim 14, further comprising:
a third X-ray generation operation comprising X-ray generators arranged in odd rows of even columns among the plurality of X-ray generators arranged in the matrix form, generating third X-rays; and
a third X-ray detection operation comprising X-ray detectors arranged in odd rows of even columns among the plurality of X-ray detectors arranged in the matrix form corresponding to the plurality of X-ray generators, detecting the generated third X-rays.

16. The method of claim 14, further comprising:
a fourth X-ray generation operation comprising X-ray generators arranged in even rows of even columns among the plurality of X-ray generators arranged in the matrix form, generating fourth X-rays; and
a fourth X-ray detection operation comprising X-ray detectors arranged in even rows of even columns among the plurality of X-ray detectors arranged in the matrix form corresponding to the plurality of X-ray generators, detecting the generated fourth X-rays.

17. The method of claim 14, wherein
the first X-ray generation operation further comprises X-ray generators arranged in even rows of even columns among the plurality of X-ray generators arranged in the matrix form, generating the first X-rays, and
the first X-ray detection operation further comprises X-ray detectors arranged in even rows of even columns among the plurality of X-ray detectors arranged in the matrix form corresponding to the plurality of X-ray generators, detecting the generated first X-rays.

18. The method of claim 14, wherein
the second X-ray generation operation further comprises X-ray generators arranged in odd rows of even columns among the plurality of X-ray generators arranged in the matrix form, generating the second X-rays, and
the second X-ray detection operation further comprises X-ray detectors arranged in odd rows of even columns among the plurality of X-ray detectors arranged in the matrix form corresponding to the plurality of X-ray generators, detecting the generated second X-rays.

19. The method of claim 14, wherein X-rays generated by each of the plurality of X-ray generators are irradiated on a region in a corresponding X-ray detector.

20. The method of claim 14, wherein each of the plurality of X-ray detectors detects only X-rays generated by a corresponding X-ray generator.
